(19) United States
(12) Patent Application Publication
(10) Pub. No.: US 2009/0206500 A1
(43) Pub. Date: Aug. 20, 2009

(54) Pre-heated combustion air in treating ceramic components

(76) Inventors: Michael Maguire, Napa, CA (US); Michael D. Baldwin, American Canyon, CA (US); Max Eric Schlienger, Napa, CA (US); Paul A. Witney, Chellaston (GB)

Correspondence Address: KRIEG DEVAULT LLP, ONE INDIANA SQUARE, SUITE 2800, INDIANAPOLIS, IN, 46204-2079, US

(21) Appl. No.: 12/070,546

(22) Filed: Feb. 19, 2008

(51) Int. Cl. B29C 35/02

(52) U.S. Cl. 264/40.6; 110/186

(57) ABSTRACT

Systems and processes are disclosed to provide pre-heated air to a furnace configured to treat ceramic green bodies which are made of a particulate material and a combustible fugitive binder. In one embodiment the furnace includes a heater disposed within an intake conduit which supplies pre-heated air to a combustion chamber disposed within the furnace.

### FIELD OF THE INVENTION

The present invention generally relates to systems and processes for treating sinterable particles, and more particularly, but not exclusively, to systems and processes for treating green bodies.

### BACKGROUND

Efficient and effective treatment of green bodies remains an area of interest. Unfortunately, some existing systems have various shortcomings relative to certain applications. Accordingly, there remains a need for further contributions in this area of technology.

### SUMMARY OF THE INVENTION

One embodiment of the present invention is a unique pre-heated-air furnace for treating green bodies composed of a fugitive binder and a particulate material. Other embodiments include apparatuses, systems, devices, hardware, methods, and combinations for pre-heating air used in furnaces that treat green bodies or articles. Further embodiments, forms, features, aspects, benefits, and advantages of the present application shall become apparent from the description and figures provided herewith.

### BRIEF DESCRIPTION OF THE FIGURES

FIG. 1 is a schematic representation of one embodiment of a combustion furnace.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In one embodiment, a furnace is provided that is capable of treating a ceramic green article that is made of a particulate material and a combustible, fugitive binder. In other embodiments, the furnace may treat metal/binder mixes as well. As used herein, the term “combustible” means having the ability to produce an exothermic reaction or otherwise react with another substance, such as an oxidizer, to produce heat and/or light. Radiant heaters are provided to supply heat to the interior of the furnace thereby raising the temperature to a level that supports combustion of the fugitive binder. A conduit is coupled to the furnace to supply pre-heated combustion gas at a temperature compatible with the internal temperature of the furnace so as to avoid or alleviate adverse thermal gradients that could be caused by cold air injection. Adverse thermal gradients produce non-uniform expansion and contraction in the green article which, in turn, create non-uniform stress and strain fields in the unfired components. Defects are more likely to form, and tend to persist in the fired component, when the green article is subject to non-uniform stress and strain fields during removal of the fugitive binder.

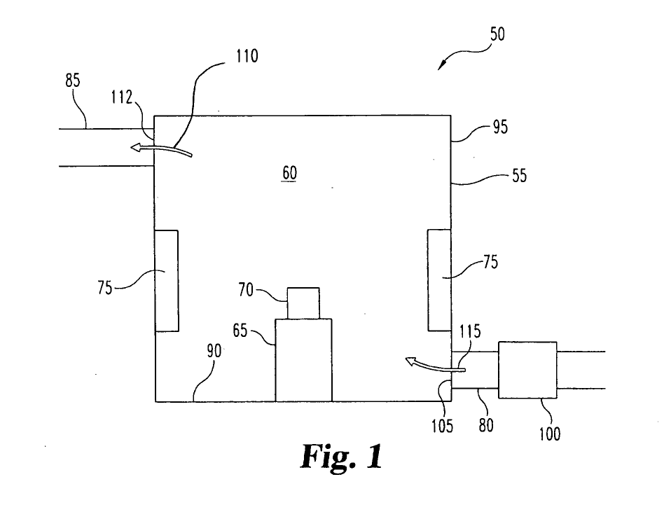

Referring to FIG. 1, a furnace 50 for sintering particulate bodies is shown having a housing 55 that encloses a chamber or heating space 60 and a pedestal 65 on which an unfired green article 70 may be placed. The furnace 50 may be used for all portions of the burnout cycle for the green article 70. Heaters 75 are located within the furnace 50 are used to raise the temperature within the chamber 60 to a level sufficient to begin or sustain a combustion process. In some embodiments, furnace 50 may be replaced with a container or other device capable of enclosing a space for heating and/or combustion. An intake conduit 80 is configured to supply a pre-heated gas that can be used for combustion to the chamber 60, while an outlet conduit 85 is used to withdraw the gas and/or products of combustion from the chamber 60. The pre-heated gas is conditioned to be delivered to the chamber 60 at a temperature sufficient to minimize adverse thermal gradients.

Housing 55 defines an enclosure for the furnace 50 and may be constructed in any suitable manner. Furthermore, insulation is provided in housing 55 to retain heat within the chamber 60. Various insulative materials can be used, but some embodiments may not use insulation, such as when heaters 75 are disposed external to the housing 55.

Chamber 60 provides an area for the heated treatment of green article 70, which treatment includes removal of the fugitive binder and sintering of the particulate material. Temperatures as high as 1750 degrees C. or greater may be reached in the chamber during the process. In some embodiments, however, the chamber may be constructed and used solely for removing the fugitive binder matrix, wherein the particulate material is sintered using another apparatus.

Pedestal 65 provides a platform to elevate the green article away from. floor 90, but in some embodiments the green article 70 may be placed in direct contact with floor 90. Pedestal 65 may be connected to any wall or other surface of furnace 50.

Green article 70 is composed of a fugitive binder matrix and a particulate material, and is capable of being processed to produce a sintered component. The particulate material can include ceramic and metal to set forth just a few nonlimiting examples. Various configurations of the green article 70 can be made through techniques such as ceramic steriolithography, gel casting, extrusion, injection molding, and tape casting, to set forth a few nonlimiting examples. The green article 70 is typically formed prior to being placed within the furnace 50 and processed.

The green article 70 is initially processed by removing the fugitive binder matrix through a combustion process to produce an intermediate article having a reduced-size shape similar to the green article 70. The intermediate article that remains is substantially composed of the particulate material and is subject to being fired in the furnace 50, or other suitable device, to produce a sintered component. In one form the fugitive binder matrix is a combustible, organic polymer binder that may be formed from acrylate resins and pre-ceramic polymers. In another form the organic polymer binder is formed from one of epoxy resins, methacrylate resins and acrylic esters. Other types of combustible fugitive binder materials are also contemplated herein.

At the appropriate activation energy, the fugitive binder matrix reacts with a combustion gas, such as air, or oxidizer to produce products of combustion through a combustion process. The combustion gas or oxidizer used in the combustion process either may be resident within the furnace 50 at the start of the combustion process, or may be provided via the intake conduit 80 as will be described further hereinbelow. The combustion process may or may not consume all of the fugitive binder and may or may not consume all of the combustion gas within the furnace 50. The combustion gas can be replenished or continuously provided to the furnace 50 via the intake conduit 80 to sustain or otherwise control the combustion process. Furthermore, the combustion gas and/or products of combustion can be removed via the outlet conduit 85.

Heaters 75 are disposed internal to housing 55 but alternatively may be placed in other locations. In particular, heaters 75 may be placed external to housing 55 or may be incorporated within a walled structure forming the contours of the housing 55. Any number of heaters may be disposed at a variety of locations either internal or external to housing 55. The heaters 75 may vary the amount of heat produced during operation to either increase or decrease the internal temperature of the housing 55, or maintain a constant temperature.

Heaters 75 are configured as radiant heaters in the illustrative embodiment. In other embodiments, the heaters 75 may take the form of any electrical resistance heater, microwave heater, or gas burner heater, to set forth just three nonlimiting examples. In one particular embodiment the heaters may take the form of graphite resistance heating elements.

An intake conduit or duct 80 is configured to supply pre-heated combustion gas (hereinafter the “pre-heated gas”) at a variety of flow rates. In some applications, the pre-heated gas can be supplied to the furnace 50 during ramp and soak portions of a burnout cycle for the green article 70. The pre-heated gas may be mixed with other gases, some of which may be inert, to control the amount of combustion gas entering the chamber. As used herein, the term “inert” shall mean a gas or other substance that does not contribute to the combustion process. In some situations, the pre-heated gas may be composed entirely of inert gas.

The intake conduit 80 is attached to the bottom of wall 95 of the housing 55, but may be configured to enter chamber 60 at any number of other locations, including at the top of wall 95 or in the top of housing 55, to set forth just two nonlimiting examples. The intake conduit 80 is insulated in the illustrative embodiment, but need not be insulated in all embodiments.

More than one intake conduit 80 may be used in some embodiments and may be arranged to deliver combustion gas or inert gas, whether preheated or not, at a variety of locations around the furnace 50. In those embodiments that contain more than one intake conduit, a mixer may be provided to mix flow from a conduit having preheated air and a conduit that does not have preheated air. Furthermore, multiple inlets 105 may be arranged around the furnace 50 to accept more than one intake conduit 80, unlike the single inlet depicted in the illustrative embodiment. In other embodiments, multiple intake conduits 80 may be in flow communication with a single inlet 105.

The combustion gas traverses through the intake conduit 80 by the action of an upstream pressure source or airflow mechanism such as a fan, compressor, or pressurized tank. The combustion gas may traverse the intake conduit 80 at a constant flow rate or varying rates. The rate that the combustion gas enters the chamber 60 from intake conduit 80 may affect the rate of combustion of the fugitive binder matrix. A flow regulator may be added in some embodiments to control the flow rate or may be added to otherwise fine tune the rate initially established by the upstream pressure source or airflow mechanism. Such a flow regulator may be placed within intake conduit 80 or in any other suitable location that is in flow communication with the chamber 60.

Intake heater 100 is provided to preheat the gas entering chamber 80 to any temperature. As discussed hereinabove, the gas entering chamber 80 may include combustion gas or a mixture of combustion and inert gases. In some situations, the gas entering chamber 80 may also be entirely inert. During operation, furthermore, the intake heater 100 may be used to vary the amount of heat produced to either increase or decrease the temperature of the gas entering the chamber. In some embodiments, the intake heater 100 may also be used to maintain a constant temperature in the gas entering the chamber. The intake heater 100 is a radiant heater, but other types of devices capable of providing heat are also contemplated. Intake heater 100 is disposed within the intake conduit 80 in the illustrative embodiment. The intake heater 100 may be disposed in the center of the intake conduit 80 in some embodiments or may be disposed around the periphery of conduit 80. Other alternative locations for the intake heater 100 are also contemplated herein. For example, the intake heater 100 may be located within the inlet 105 of housing 55 which may provide a situation in which the intake conduit 80 may not be needed.

More than one intake heater 100 may be provided depending upon the particular needs of a given application. In one embodiment, more than one intake heater 100 may be provided within the intake conduit 80. If, however, more than one intake conduit 80 is used, then multiple intake heaters 100 may also be used, but not all intake conduits 80 need have an intake heater 100. Furthermore, if more than one intake heater 100 is provided, not all heaters may be operated at the same time. For example, some intake heaters may be continuously operating while others are configured to regulate the temperature of the gas entering the chamber 80.

An outlet conduit or duct 85 is configured at the top of furnace 50 and is used to extract outlet flow 110 composed of combustion gas and/or products of combustion from the outlet 112 of chamber 60. The outlet flow 110 may alternatively and/or additionally be composed of inert gas. It will be understood that outlet conduit 85 may be configured to exit chamber 60 at any number of locations around housing 55, including at the bottom or top of housing 55. In some embodiments, outlet conduit 85 may not be needed, and in other embodiments more than one outlet conduit 85 may be used. In operation, combustion gas, products of combustion, and/or inert gas is extracted through outlet conduit 85 by operation of a source upstream of intake conduit 80 pushing the gases through the chamber 60. Outlet flow 110 traverses outlet conduit 85 at the same rate as intake flow 115 enters chamber 60. If, however, losses occur such that some mass flow exits chamber 60 at locations other than outlet conduit 85, then the rate of outlet flow 110 may be less than the rate of intake flow 115. Such would be the case in an embodiment that includes a pressure relief valve in furnace 50 that operates when needed.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus for processing a green article comprising:
a furnace having a heater and an intake; and
an intake heater structured to preheat a gas entering the furnace through the intake.

2. The apparatus of claim 1 which further includes a passageway for supplying the gas to the furnace.

3. The apparatus of claim 1 which further includes a regulator structured to regulate the flow rate of the gas entering the furnace.

4. The apparatus of claim 1 wherein the gas contains oxygen.

5. The apparatus of claim 1 which further includes a green article, the green article includes a combustible binder and a particulate material.

6. The apparatus of claim 5 wherein the particulate material is ceramic.

7. The apparatus of claim 5 wherein the particulate material is a metallic material.

8. The apparatus of claim 5 wherein the combustible binder is an organic polymer.

9. The apparatus of claim 5 wherein the combustible binder is selected from the group consisting of acrylate resins and pre-ceramic polymers.

10. The apparatus of claim 5 wherein the combustible binder is selected from the group consisting of epoxy resins, methacrylate resins and acrylic esters.

11. A method comprising:
placing a green article in a chamber, the green article including a combustible binder and a particulate material;
heating the chamber to a combustion temperature; and
supplying preheated gas to the chamber.

12. The method of claim 11 which further includes regulating the flow rate of preheated gas to the chamber.

13. The method of claim 11 which further includes varying the temperature of the preheated gas to a predetermined temperature.

14. The method of claim 11 which further includes combusting the combustible binder.

15. The method of claim 11 which further includes sintering the particulate material after at least a portion of the combustible binder has been removed.

16. A method comprising:
forming a green article comprised of a binder and a particulate material into a desired configuration;
heating the green article in a container;
removing the binder by combustion; and
flowing a preheated gas into the container at a desired temperature.

17. The method of claim 16 which further includes thermodynamically coupling a heater to the duct such that gas being conveyed in the duct is heated to a preheated gas temperature.

18. The method of claim 16 wherein the thermodynamically coupling includes changing the temperature of the preheated gas.

19. The method of claim 16 which further includes sintering the particulate material after removing the binder by combustion.
